(19) United States
(12) Patent Application Publication
(10) Pub. No.: US 2021/0135305 A1
(43) Pub. Date: May 6, 2021

(54) FULL PERIMITER CYLINDRICAL CELL BATTERY CARRIER

(71) Applicant: Hanon Systems, Daejeon (KR)

(72) Inventors: Leigh David, Daventry (GB); Steve Joyce, Surrey (GB); Tom Kelham, Woodford Green (GB)

(21) Appl. No.: 16/798,852

(22) Filed: Feb. 24, 2020

Related U.S. Application Data
(60) Provisional application No. 62/928,440, filed on Oct. 31, 2019.

(51) Int. Cl. H01M 10/643; H01M 2/10; H01M 10/625; H01M 10/6567; H01M 10/6556

(52) U.S. Cl. CPC H01M 10/643; H01M 2/1077; H01M 2220/20; H01M 10/6567; H01M 10/6556; H01M 10/625

(57) ABSTRACT

A heat exchanger assembly includes a pair of opposing header tanks and a heat exchanger core disposed between the opposing header tanks. The heat exchanger core is formed by a plurality of parallel arranged carrier modules with at least one fluid channel disposed adjacent each of the carrier modules. Each of the fluid channels is configured to receive a dielectric coolant passed between the opposing header tanks. Each of the carrier modules includes a frame and at least one cell pocket merged with the frame. Each of the cell pockets is configured to receive a substantially cylindrical battery cell therein.

### CROSS-REFERENCE TO RELATED APPLICATION

This patent claims priority to U.S. Provisional Patent Application Ser. No. 62/928,440, filed on Oct. 31, 2019, the entire disclosure of which is hereby incorporated herein by reference.

### FIELD OF THE INVENTION

The present invention relates to a heat exchanger assembly for use with a battery assembly of a motor vehicle, and more particularly, a modular battery cell carrier of the heat exchanger assembly.

### BACKGROUND OF THE INVENTION

Electric vehicles and hybrid electric vehicles typically include a battery assembly for generating the power necessary to drive the associated vehicle. The battery cells forming such assemblies tend to generate significant heat during operation or charging thereof. It is therefore necessary to cool the battery cells in order to maintain the battery cells within a desired operational temperature range, which coincides with the battery cells operating with a maximized efficiency. Alternatively, in some circumstances, such as when the vehicle is first being started in especially cold conditions, it may also be beneficial to quickly heat the battery cells to a temperature within the desired operational temperature range to once again ensure that the battery cells are operating with a maximized efficiency. In either circumstance, it is beneficial for the desired degree of heat transfer to occur quickly in reaction to a change in conditions in order to ensure that the battery cells continue to operate within the desired operational temperature range.

One method of transferring heat to or from the battery cells forming the associated battery assembly includes placing a heat sink in heat exchange relationship with one or more of the battery cells. However, the heat sink must typically be electrically isolated from the battery cells to prevent an undesired flow of the current associated with the battery cells through the heat sink to adjacent components of the battery assembly or the vehicle. For example, many heat sinks are also in fluid communication with a coolant such as water that is capable of carrying an electric current therethrough, hence it is of particular importance to electrically isolate the battery cells from such electrically conductive coolants. As such, it is common for such heat sinks to be electrically isolated from the associated battery cells by introducing a layer of an electrical insulator at the interface between the battery cell and the heat sink.

However, such electrical insulators also disadvantageously provide a form of thermal insulation between the battery cells and the heat sink while further lengthening the thermal pathway necessary for the heat to travel when being transferred to or from the battery assembly. This tends to contribute to the thermal lag and hysteresis mentioned above regarding the manner in which the battery cells may at times fail to be heated or cooled quickly enough to maintain the battery cells within the desired operational temperature range in reaction to changes in the conditions or circumstances faced by the battery assembly.

There accordingly exists a need in the art for an improved heat sink structure for use with a battery assembly, wherein the heat sink structure has improved heat exchange characteristics for more effectively and efficiently cooling the battery cells of the associated battery assembly in a timely and efficient manner.

### SUMMARY OF THE INVENTION

Compatible and attuned with the present invention, an improved heat sink structure for use with a battery assembly has surprisingly been discovered.

According to an embodiment of the invention, a carrier module for a heat exchanger comprises a frame and a cell pocket merged with the frame, the cell pocket configured to receive a substantially cylindrical battery cell therein.

A heat exchanger assembly is also disclosed according to another aspect of the present invention. The heat exchanger assembly includes a first header tank, a second header tank arranged opposite the first header tank, and a heat exchanger core formed by a plurality of parallel arranged carrier modules and a plurality of fluid channels providing fluid communication between the first header tank and the second header tank. Each of the carrier modules includes a frame and at least one cell pocket merged with the frame, with each of the at least one cell pockets configured to receive a substantially cylindrical battery cell therein. Each of the carrier modules is disposed adjacent at least one of the fluid channels and is in heat exchange relationship with a fluid passed through the fluid channels.

### BRIEF DESCRIPTION OF THE DRAWINGS

The above, as well as other objects and advantages of the invention, will become readily apparent to those skilled in the art from reading the following detailed description of an embodiment of the invention when considered in the light of the accompanying drawings:

FIG. 1 is a side elevational view of a carrier module for use in a heat exchanger assembly according to an embodiment of the present invention;

FIG. 2 is a top plan view of the carrier module of FIG. 1;

FIG. 3 is an enlarged fragmentary view of one of the cell pockets of the carrier module of FIGS. 1 and 2;

FIG. 4 is a schematic view the electrical connections associated with the carrier module of FIGS. 1 and 2;

FIG. 5 is a cross-sectional elevational view of a heat exchanger assembly according to an embodiment of the present invention, wherein the heat exchanger assembly utilizes a plurality of carrier modules as disclosed in FIGS. 1 and 2 as well as heat exchanger tubes in heat exchange relationship with the carrier modules;

FIG. 6 is a cross-sectional elevational view of a heat exchanger assembly according to another embodiment of the present invention, wherein the heat exchanger assembly utilizes the carrier modules as disclosed in FIGS. 1 and 2 as well as modified double-row carrier modules, wherein heat exchanger tubes are in heat exchange relationship with each disclosed type of the carrier modules;

FIG. 7 is a cross-sectional elevational view of a heat exchanger assembly according to another embodiment of the invention, wherein the heat exchanger assembly utilizes a plurality of spaced apart carrier modules with fluid channels formed between adjacent ones of the carrier modules;

FIG. 8 is a side elevational view of a face plate for use with the heat exchanger assembly of FIG. 7;

FIG. 9 is an exploded top plan view of the heat exchanger assembly of FIG. 7 and a pair of the face plates as disclosed in FIG. 8; and

FIG. 10 is a cross-sectional elevational view of a heat exchanger assembly according to yet another embodiment of the invention, wherein the heat exchanger assembly utilizes a combination of single rowed carrier modules and double rowed carrier modules with the spaces present between adjacent ones of the carrier modules forming fluid channels.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

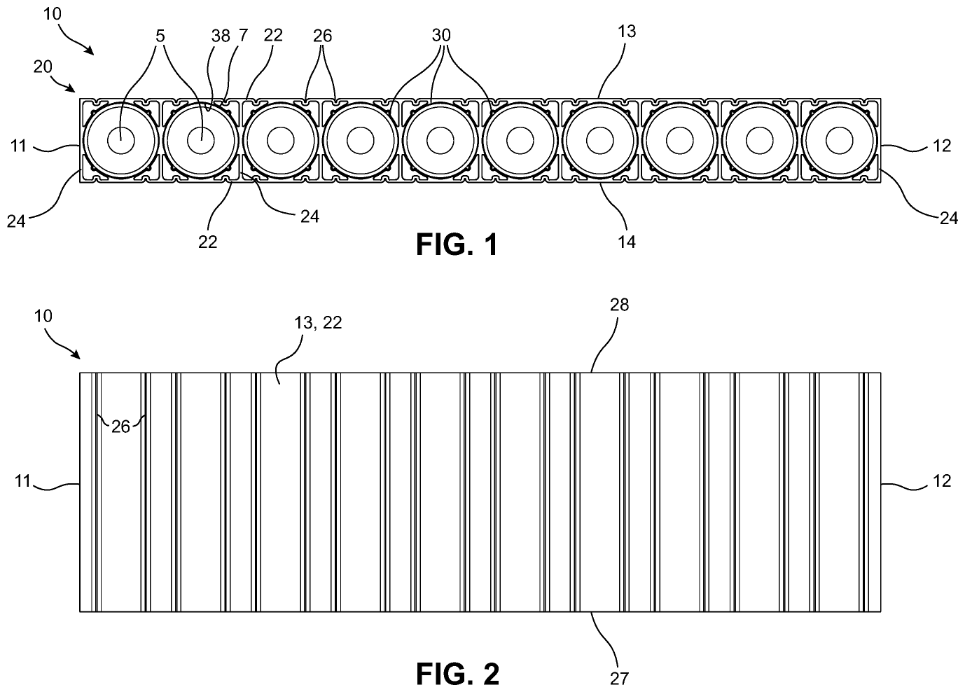

FIGS. 1 and 2 illustrate an exemplary carrier module 10 according to an embodiment of the present invention. The carrier module 10 is configured to act as a heat sink structure for transferring heat to or from an associated plurality of battery cells 5.

Each of the features of the carrier module 10 is formed as a part of a single, continuous and integrally formed structure. In other words, all of the described features of the carrier module 10 are monolithically formed in a common manufacturing process. As such, all of the features of the carrier module 10 are formed from a common and continuous material, such as a thermally conductive metallic material. This continuous material accordingly allows for all of the different features of the carrier module 10 to be in conductive heat exchange communication with each other without any intervening seams or joints, thereby reducing the thermal path of the heat flowing to or from the associated battery cells 5. The carrier module 10 may also be formed from an electrically conductive material, thereby leading to all of the features of the carrier module 10 being in conductive electrical communication with each other. The carrier module 10 may be formed from aluminum or alloys thereof having the requisite thermal and electrical conductivity, as one non-limiting example. However, one skilled in the art should appreciate that any thermally and electrically conductive material may be used for forming the carrier module 10 without necessarily departing from the scope of the present invention.

Referring to FIGS. 1 and 2, the carrier module 10 is comprised of a frame 20 and at least one cell pocket 30. In the provided example, the carrier module 10 includes ten of the cell pockets 30 arranged in a rectilinear configuration corresponding to a row of the cell pockets 30, but any number of the cell pockets 30 may be utilized without departing from the scope of the present invention. The carrier module 10 extends longitudinally from a first end 11 to a second end 12 thereof, and includes opposing longitudinal sides 13, 14 connecting the first and second ends 11, 12. The cell pockets 30 are accordingly spaced apart from each other with respect to the longitudinal, or length direction of the carrier module 10.

The frame 20 is comprised of a pair of longitudinal members 22 with each of the longitudinal members 22 disposed at diametrically opposed sides of each of the cell pockets 30. The frame is further comprised of a plurality of cross members 24, wherein each of the longitudinally spaced cell pockets 30 is disposed between a pair of the cross members 24 with respect to the length direction of the carrier module 10. The longitudinal members 22 extend in the length direction of the carrier module 10 while each of the cross members 24 extends in a height direction of the carrier module 10 arranged perpendicular to the length direction. The outermost ones of the cross members 24 cooperate with the pair of the longitudinal members 22 to form a perimeter shape of the carrier module 10, which in the present case is a rectangular perimeter shape. The cross members 24 are all arranged to extend in parallel and may be spaced from each other equally with respect to the length direction of the carrier module 10, as desired. However, in other embodiments, the cell pockets 30 and hence the cross members 24 may be spaced variably in the length direction of the carrier module 10 without departing from the scope of the present invention.

A width direction of the carrier module 10 extends into the page with respect to the perspective of FIG. 1 and in the vertical direction of the page with respect to the perspective of FIG. 2. The carrier module 10 may be formed by extruding the material forming the carrier module 10 in the width direction thereof from a first face 27 to an oppositely arranged second face 28 of the carrier module 10, thereby causing the carrier module 10 to have a substantially constant and consistent cross-sectional shape with respect to any width of the carrier module 10, within the tolerances of the extrusion process. However, the carrier module 10 may be manufactured integrally and monolithically by alternative means, such as by die molding, as desired, without necessarily departing from the scope of the present invention.

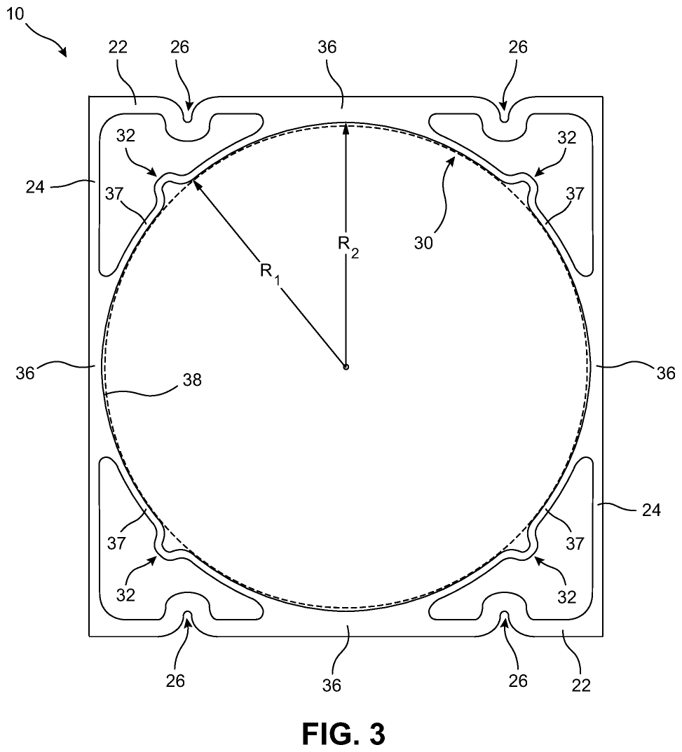

Each of the cell pockets 30 is formed as a cylindrical shell configured to surround and contact one of the battery cells 5 about a maximized portion of a circumference thereof in order to maximize the amount of thermal contact between the outer circumferential surface 7 of the corresponding battery cell 5 and the inner circumferential surface 38 of the corresponding cell pocket 30. As best shown in the fragmentary and enlarged view of FIG. 3, each of the cell pockets 30 merges with the frame 20 at one of a plurality of circumferentially spaced connecting portions 36. Specifically, each of the cell pockets 30 includes one of the connecting portions 36 for merging with each of the pair of the longitudinal members 22 and each of an adjacent pair of the cross members 24 such that each of the cell pockets 30 merges with the frame 20 at four different locations spaced 90 degrees about the circumference of the corresponding cell pocket 30. Each of the connecting portions 36 may extend about approximately 30-45 degrees of the circumference of the corresponding cell pocket 30, as desired, but other ranges may be used without necessarily departing from the scope of the present invention. Each of the cell pockets 30 further includes a plurality of shell portions 37, wherein each of the shell portions 37 is provided as a relatively thin wall segment extending circumferentially between adjacent ones of the connecting portions 36. Each of the shells portions 37 may include a cross-sectional shape that substantially resembles that of a segment of a circle, although the shell portions 37 may have a substantially irregular or oblong shape as described in greater detail hereinafter.

In the illustrated embodiment, each of the shell portions 37 includes a corrugation 32 formed therein and equally spaced in the circumferential direction from the two adjacent ones of the connecting portions 36, thereby resulting in each of the cell pockets 30 including four of the corrugations 32 spaced from each other by about 90 degrees about the circumferential direction of the corresponding cell pocket 30. However, each of the cell pockets 30 may instead be formed to be entirely devoid of the corrugations 32, or may include any alternative number of the corrugations 32 at any desired circumferential spacing, without departing from the scope of the present invention. In some embodiments, each of the cell pockets 30 may include the corrugations 32 formed at only two diametrically opposed positions corresponding to two of the four quadrants of each of the cell pockets 30, as one non-limiting example. In other embodiments, each of the shell portions 37 may include a plurality of the corrugations 32 between adjacent ones of the connecting portions 36. The plurality of corrugations 32 formed in one of the shell portions 37 may be equally spaced from each other or may be variably spaced from each other with respect to the circumferential direction of each of the cell pockets 30, as desired.

The corrugations 32 are substantially arcuate in shape, but may alternatively include a substantially triangular or rectangular cross-sectional shape while connecting adjacent portions of the corresponding shell portion 37, as desired. The corrugations 32 are provided to allow for each of the arcuate shell portions 37 of each of the cell pockets 30 disposed between adjacent ones of the connecting portions 36 to flex inwardly or outwardly relative to a center of the corresponding one of the cell pockets 30 in order to accommodate thermal stresses formed within the cell pockets 30 caused by the heat being transferred to or from the corresponding battery cells 5. For example, the corrugations 32 may allow for each of the cell pockets 30 to expand outwardly via an outward flexing of each of the arcuate shell portions 37 in order to accommodate a thermal expansion of the corresponding battery cells 5.

Each of the cell pockets 30 may be formed to be slightly oblong in at least one radial direction in a manner wherein at least one portion of the circumference of each of the cell pockets 30 has a different radius than an adjacent portion of the same cell pocket 30. In the illustrated embodiment, the radius of each of the cell pockets 30 varies from a minimum radius R₁ provided within each of the shell portions 37 immediately adjacent each side of each of the corrugations 32 to a maximum radius R₂ provided in radial alignment with a center of each of the connecting portions 36. The outward expansion of the cell pocket 30 at each of the connecting portions 36 is shown in FIG. 3 via comparison of the shape of the inner circumferential surface 38 of the illustrated cell pocket 30 relative to a circle having the minimum radius R₁ as shown in broken line form. This variation in the radius of each of the cell pockets 30 about the circumference thereof allows for each of the cell pockets 30 to accommodate battery cells 5 having irregular dimensions or shapes within the tolerances of the manufacturing process used in forming each of the cylindrically shaped battery cells 5. Additionally, the varying radiuses allow for the cell pockets 30 to flex radially outwardly at each of the corrugations 32 to form a substantially circular profile of the inner circumferential surface 38 of the corresponding one of the cell pockets 30, thereby aiding in conforming the inner circumferential surface 38 of the cell pocket 30 to the shape of the outer circumferential surface 7 of the corresponding battery cell 5. The variable radius accordingly ensures that each of the battery cells 5 maintains close contact with the inner circumferential surface 38 of the corresponding cell pocket 30 even in the presence of dimensional variations, which in turn ensures a suitable electrical and thermal pathway between the outer circumferential surface 7 of each of the battery cells 5 and the inner circumferential surface 38 of each of the cell pockets 30.

Each of the longitudinal members 22 forming the frame 20 of one of the carrier modules 10 may optionally include at least one coupling groove 26 formed therein. Each of the coupling grooves 26 is provided as a corrugation projecting in the height direction of the carrier module 10 with a convex surface of each of the coupling grooves 26 facing inwardly towards one of the cell pockets 30 while a concave surface of each of the coupling grooves 26 faces outwardly. The coupling grooves 26 may be provided in a manner wherein each of the coupling grooves 26 of one of the carrier modules 10 faces towards and opposes the coupling grooves 26 formed in an adjacent one of the carrier modules 10, wherein the concave surfaces of the opposing coupling grooves 26 face towards each other. The opposing concave surfaces are provided to aid in coupling adjacent ones of the carrier modules 10 to each other in an aggressive joining process such as brazing or welding. Specifically, the opposing coupling grooves 26 may cooperate with each other to form an enlarged opening for receiving clad material disposed on an outer surface of the carrier modules 10 for ensuring a robust and secure coupling between adjacent ones of the carrier modules 10. In other circumstances, the concave surface of at least one of the coupling grooves 26 may face towards a substantially planar surface of another one of the carrier modules 10 or an adjacent component such as a fluid communicating tube, as desired. However, as explained hereinafter, the carrier modules 10 may be provided in the absence of the coupling grooves 26 in circumstances where the carrier modules 10 are not directly coupled to each other, but instead are provided independently and are spaced from each other.

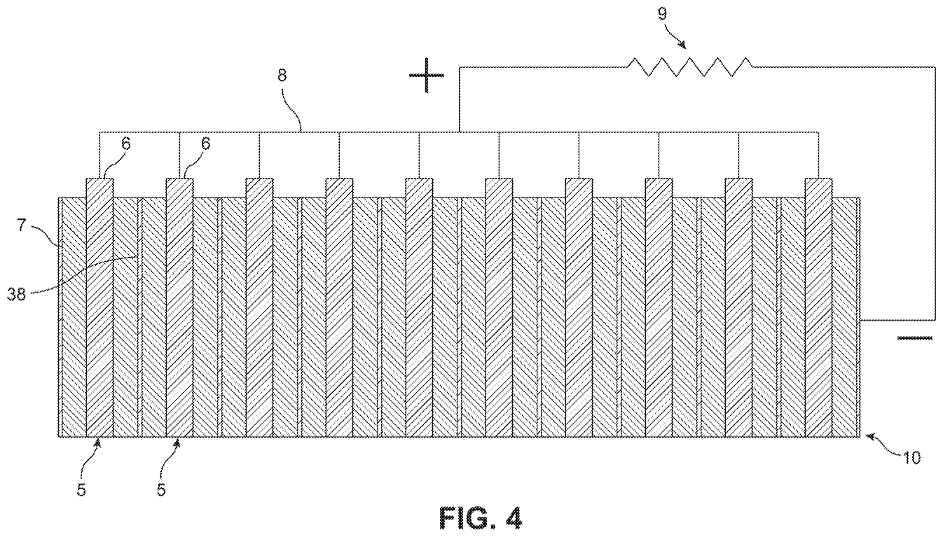

The manner in which the entirety of each of the carrier modules 10 is formed from a continuous electrically conductive material allows for each of the carrier modules 10 to act as a busbar for connecting the plurality of the battery cells 5 in a parallel electrical configuration. For example, FIG. 4 schematically illustrates one electrical configuration regarding the plurality of the battery cells 5 disposed within one of the carrier modules 10 wherein the outer circumferential surface 7 of each of the battery cells 5 is placed in electrically conductive contact with the inner circumferential surface 38 of a corresponding one of the cell pockets 30 in a manner wherein the carrier module 10 acts as a negative busbar that is electrically coupled to a negative terminal of each of the battery cells 5 as formed by the outer circumferential surface 7 of each of the battery cells 5. In contrast, each of the battery cells 5 further includes a positive terminal illustrated in the form of an axially extending projection 6 that is electrically insulated or spaced from the carrier module 10 acting as negative busbar. The projections 6 acting as the positive terminals are each electrically coupled to a positive busbar 8 that is once again electrically insulated or spaced from the carrier module 10. The plurality of the battery cells 5 is accordingly electrically connected in parallel between the negative busbar formed by the carrier module 10 and the positive busbar 8 associated with each of the axially extending projections 6. The electrical energy generated by the battery cells 5 is accordingly able to be delivered to a load 9 associated with the battery cells 5, wherein the load 9 may represent the electrical components of a motor vehicle being powered at least partially by the plurality of the battery cells 5.

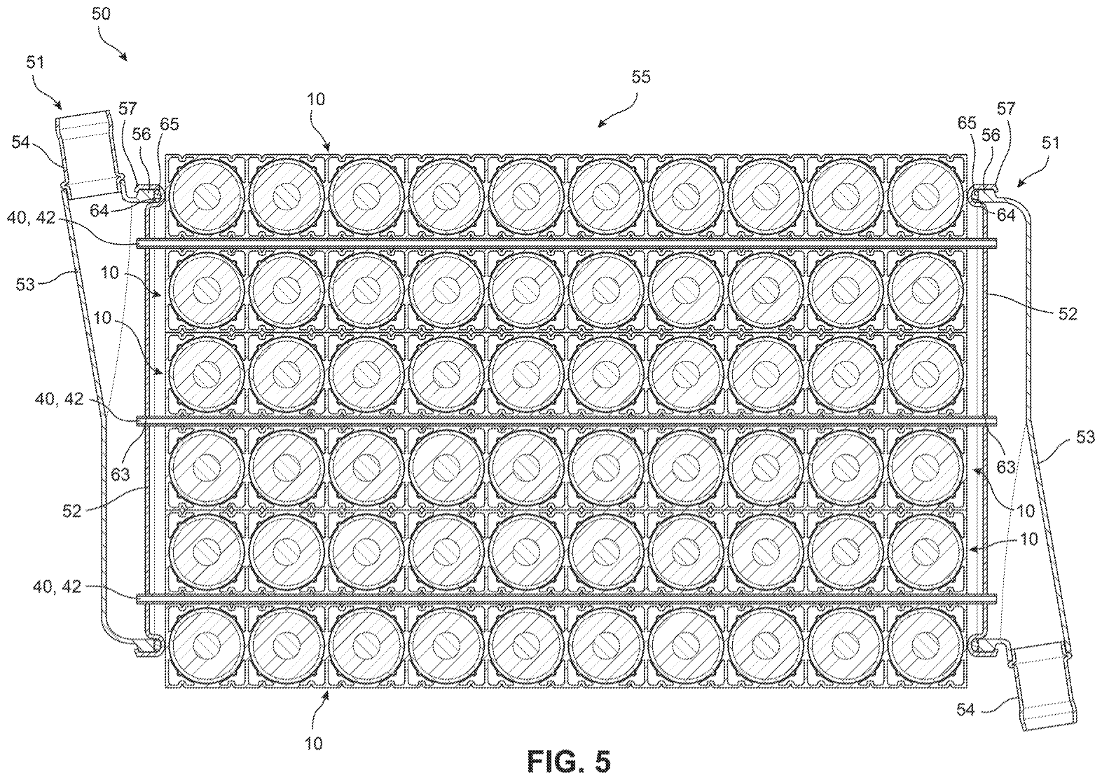

Referring now to FIG. 5, a plurality of the carrier modules 10 as shown and described herein may be utilized in forming a heat exchanger assembly 50 according to an embodiment of the present invention. The heat exchanger assembly 50 includes a pair of opposing header tanks 51 and a heat exchanger core 55 formed by the plurality of the carrier modules 10. The carrier modules 10 are arranged in parallel as the carrier modules 10 extend longitudinally between the header tanks 51. The cylindrical battery cells 5 are received within the substantially cylindrical cell pockets 30 with any tolerance variations in the battery cells 5 accommodated by the variable radius of the cell pockets 30 as well as the flexibility of the cell pockets 30 at each of the corrugations 32 thereof

Each of the header tanks 51 includes a header plate 52, a manifold tank 53, and a spigot 54. The header plate 52 may be substantially planar and may include a plurality of tube openings 63 formed therein. The tube openings 63 may be spaced from each other in a longitudinal direction of each of the header plates 52, which corresponds to the height direction of each of the carrier modules 10 forming the heat exchanger core 55. In the provided embodiment, each of the tube openings 63 may include a substantially rectangular or rounded rectangular cross-sectional shape, as desired. The tube openings 63 may each include a width substantially corresponding to a width of each of the carrier modules 10, as desired.

The manifold tank 53 defines a fluid reservoir for receiving or distributing a coolant associated with cooling the battery cells 5 disposed within the carrier modules 10 forming the heat exchanger core 55. Each of the manifold tanks 53 may include a peripherally extending foot 56 surrounding an opening into an interior of each of the manifold tanks 53. In the illustrated embodiment, tabbed portions 57 formed about a periphery of each of the header plates 52 may be folded or bent over the foot 56 of the corresponding one of the manifold tanks 53 to couple each of the header plates 52 to the corresponding one of the manifold tanks 53.

Each of the header plates 52 may further include a peripherally extending trough 64 having a seal 65 disposed therein. The trough 64 of each of the header plates 52 may be configured to receive the foot 56 of the corresponding manifold tank 53 therein with the corresponding one of the seals 65 compressed therebetween, thereby establishing a fluid tight seal at the junction of each of the manifold tanks 53 and header plates 52.

The spigot 54 of each of the header tanks 51 forms an inlet or outlet for the coolant passing through the heat exchanger assembly 50. Each of the spigots 54 may be coupled to the corresponding one of the manifold tanks 53 by any suitable coupling method, as desired.

In the embodiment shown in FIG. 5, the heat exchanger assembly 50 further includes a plurality of fluid channels 40 formed therein, wherein each of the fluid channels 40 is associated with two adjacent ones of the carrier modules 10. Each of the fluid channels 40 provides fluid communication between an interior of each of the opposing header tanks 51 with respect to the coolant. In the provided embodiment, the fluid channels 40 are formed by thin walled heat exchanger tubes 42 extending between the opposing header plates 52 of the opposing header tanks 51, wherein end portions of the heat exchanger tubes 42 may be received through the tube openings 63 formed in each of the opposing header plates 52. The heat exchanger tubes 42 may be formed from a thermally conductive material suitable for exchanging heat with the thermally conductive material forming each of the carrier modules 10. In some embodiment, each of the heat exchanger tubes 42 may be formed from a metallic material, such as aluminium or alloys thereof. The material selected for forming the heat exchanger tubes 42 may be the same material as that selected for forming the carrier modules 10, as desired. Each of the heat exchanger tubes 42 may include a width substantially equal to a width of each of the carrier modules 10 to ensure that a maximized surface area of each of the carrier modules 10 is placed in thermally conductive contact with each of the associated heat exchanger tubes 42. The heat exchanger tubes 42 also include the aforementioned rectangular or rounded rectangular cross-section shape corresponding to the cross-sectional shape of each of the tube openings 63 formed in the header plates 52. The heat exchanger tubes 42 may be securely coupled to each of the header plates 52 around a periphery of each of the tube openings 63 using an aggressive coupling method such as welding or brazing. However, as explained hereinbelow, alternative configurations of the fluid channels 40 may be utilized without departing from the scope of the present invention.

The manner in which each of the fluid channels 40 is associated with a pair of the carrier modules 10 results in the outermost ones of the carrier modules 10 being provided individually while the remainder of the carrier modules 10 are provided in coupled pairs intermediate the outermost carrier modules 10. The paired couples may be formed using the coupling grooves 26 as described hereinabove for more easily joining the carrier modules 10 along those sides of the carrier modules 10 facing towards each other. Those coupling grooves 26 facing outwardly towards each of the heat exchanger tubes 42 also aid in forming a secure bond between the outer surface of the corresponding carrier module 10 and the substantially planar outer surface of each of the heat exchanger tubes 42.

As mentioned previously, the carrier modules 10 may be formed from an electrically conductive material to allow for the carrier modules 10 to act as busbar for connecting a plurality of the battery cells 5 in parallel. The parallel electrical connection may include each of the battery cells 5 of a single one of the outermost rows connected in parallel, each of the two rows of the battery cells 5 of each of the coupled together carrier module 10 pairs connected in parallel, each of the battery cells 5 of the entire heat exchanger core 55 connected in parallel, or combinations thereof, as desired. The connection of the battery cells 5 of the spaced apart carrier modules 10 may be accomplished by providing the heat exchanger tubes 42 to also be electrically conductive in substantially the same manner as the carrier modules 10. The heat exchanger tubes 42 may accordingly be utilized to form one enlarged busbar including each of the carrier modules 10 and each of the heat exchanger tubes 42, wherein all of the battery cells 5 of the entire heat exchanger core 55 are placed in electrical connection with each other.

The manner in which the carrier modules 10 are provided to be electrically conductive may facilitate the selection of a dielectric fluid as the coolant flowing through the heat exchanger assembly 50 to prevent the undesired flow of current into or out of the heat exchanger assembly 50, and especially in instances wherein the fluid channels 40 are formed by structures in electrical conductive communication with one or more of the carrier modules 10 as described hereinabove. However, the beneficial features relating to the structure of each of the carrier modules 10 may still be appreciated even when a non-dielectric fluid is utilized as the coolant.

Although not pictured, one skilled in the art should appreciate that the heat exchanger assembly 50 may be modified to include each of the carrier modules 10 being surrounded by a pair of the heat exchanger tubes 42 while remaining within the scope of the present invention. Such a configuration may be utilized when it is desired to increase the heat exchange capacity between the coolant and the carrier modules 10 in comparison to the configuration illustrated in FIG. 5.

The heat exchanger assembly 50 operates as follows. The coolant is circulated through a corresponding coolant circuit in a manner wherein the coolant flows from one of the header tanks 51 to the other of the header tanks 51 while traversing the fluid channels 40 formed by the heat exchanger tubes 42. The battery cells 5 generate heat that is transferred through the cell pockets 30 to the frame 20 of each of the carrier modules 10. The heat is then transferred from the frame 20 of each of the carrier modules 10 to the abutting one of the heat exchanger tubes 42, each of which in turn transfers the heat transferred thereto to the coolant passing therethrough. The heat generated by the battery cells 5 is accordingly removed from the heat exchanger core 55 via the flow of the coolant, whereby the heat transferred to the coolant may in turn be released to the environment via an undisclosed heat exchanger such as a radiator associated with the coolant circuit having the heat exchanger assembly 50. The carrier modules 10 may also be configured to operate as a busbar as described hereinabove, thereby aiding in forming the desired parallel electrical connection with each of the associated battery cells 5.

The illustrated carrier modules 10 provide numerous advantageous features. The shape and configuration of the cell pockets 30 allows for close thermal contact to be made with a maximized portion of the outer circumferential surface of each of the battery cells 5. The variable radiuses and the corrugations 32 found about the circumference of each of the cell pockets 30 also allows for tolerance variations introduced into the battery cells 5 during the manufacturing thereof to be overcome, regardless of whether the battery cells 5 are at maximum or minimum dimensional tolerances. The flexibility of the cell pockets 30 also aids in accommodating the vibrations and shocks that may be experienced by the battery cells 5 during operation of the associated vehicle. The use of dielectric coolant fluids also provides additional safety benefits over the use of traditional fluids.

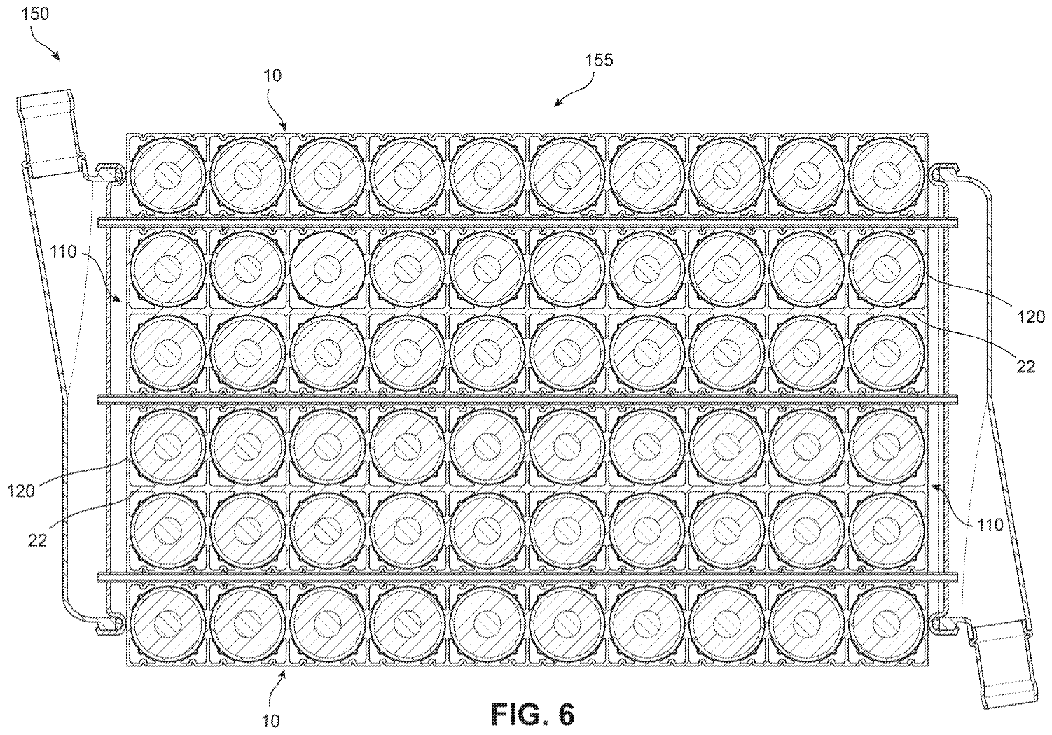

FIG. 6 illustrates a heat exchanger assembly 150 according to another embodiment of the present invention. The heat exchanger assembly 150 is substantially identical to the heat exchanger assembly 50 except each of the coupled pairs of the carrier modules 10 forming the innermost rows of the cell pockets 30 of FIG. 5 have been replaced with a modified carrier module 110 including two rows of the cell pockets 30 formed as a single and continuous body, such as by the previously described extrusion process used to form the carrier modules 10. However, the outermost carrier modules 10 include the same structure as disclosed in the heat exchanger assembly 50 of FIG. 5, hence two different carrier module configurations are utilized in forming the heat exchanger assembly 150.

Each of the carrier modules 110 may be extruded to concurrently include the two rows of the cell pockets 30 in order to avoid the need for a seam between adjacent ones of the carrier modules 10, thereby eliminating one potential break in the thermal and electrical pathway formed between adjacent ones of the carrier modules 10. A frame 120 of each of the modified double-row extruded carrier modules 110 accordingly includes an additional centrally located one of the longitudinal members 22 separating the adjacent rows of the cell pockets 30 from each other along a length of each of the carrier modules 110. The heat exchanger assembly 150 operates identically to the heat exchanger assembly 50, hence further discussion thereof is omitted.

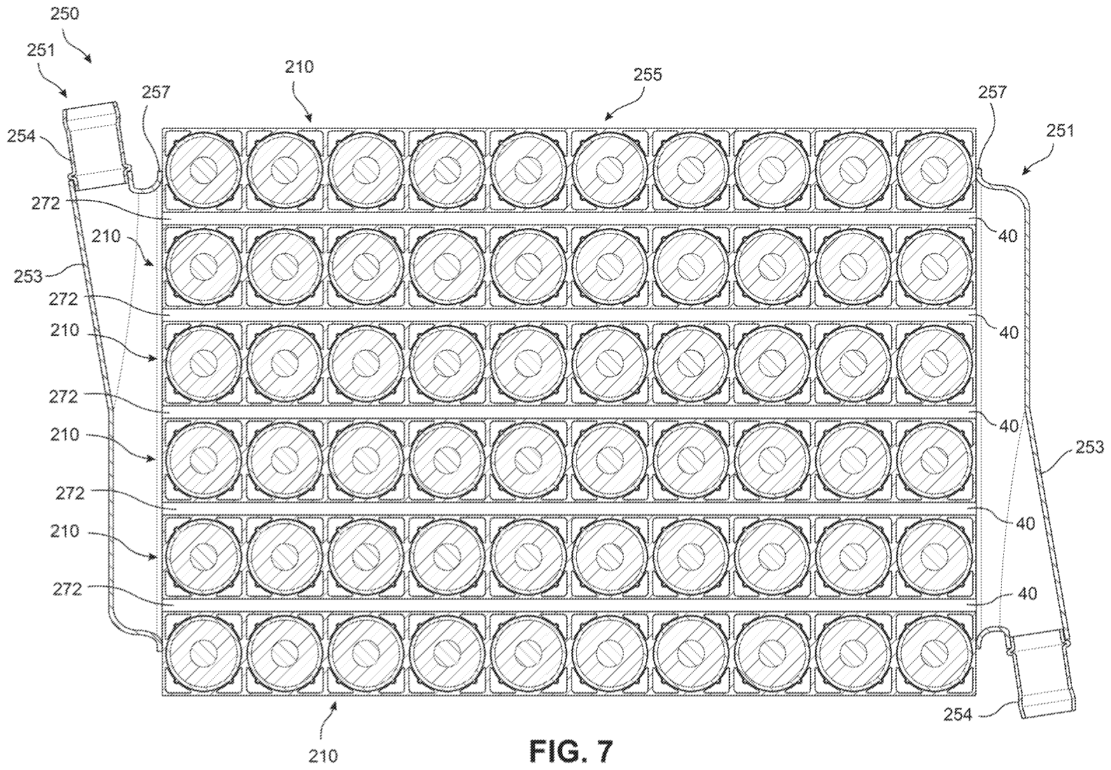

Referring now to FIGS. 7-9, a heat exchanger assembly 250 according to another embodiment of the present invention is disclosed. The heat exchanger assembly 250 is substantially similar to the heat exchanger assembly 50 and includes a heat exchanger core 255 disposed between a pair of opposing header tanks 251. Each of the header tanks 251 includes a manifold tank 253 and a spigot 254. Each of the header tanks 251 is accordingly devoid of any type of associated header plate. Instead, each of the header tanks 251 includes a peripheral portion 257 defining an opening into a hollow interior of each of the manifold tanks 253, wherein the peripheral portion 257 is configured for coupling to the end surfaces of the heat exchanger core 255 as described hereinafter.

The heat exchanger assembly 250 differs from the heat exchanger assemblies 50, 150 due to the inclusion of carrier modules 210 that are provided individually and spaced apart from each other to form each of the fluid channels 40 between each adjacent pair of the spaced apart carrier modules 210. Because the carrier modules 210 are not coupled to each other or to intervening heat exchanger tubes, each of the carrier modules 210 is extruded or otherwise produced to be devoid of the coupling grooves 26. Instead, the longitudinal members 22 of each of the carrier modules 210 are provided to be substantially planar along a length of each of the carrier modules 210. The carrier modules 210 are otherwise identical in form and configuration to the carrier modules 10, hence further description thereof is omitted.

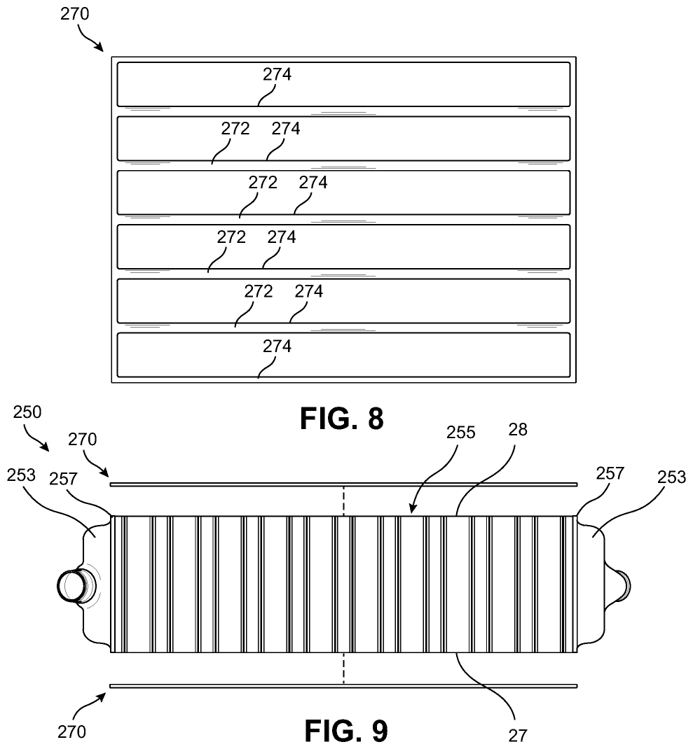

FIG. 8 illustrates one exemplary face plate 270 that may be utilized to delimit the lateral flow of the coolant through each of the fluid channels 40 formed between adjacent ones of the carrier modules 210. The face plate 270 may include a plurality of cross-bars 272 extending in a longitudinal direction of each of the carrier modules 210 with adjacent ones of the cross-bars 272 defining openings 274 therebetween. Each of the cross-bars 272 forms a laterally disposed wall for delimiting lateral flow of the coolant (into the page from the perspective of FIG. 7) when passing between adjacent ones of the carrier modules 210. The openings 274 are provided to allow for access to end portions of each of the battery cells 5, as desired.

As illustrated in FIG. 9, one of the face plates 270 may be coupled to each of the opposing faces 27, 28 of each of the carrier modules 210 forming the heat exchanger core 255. The face plates 270 are illustrated in FIG. 9 as abutting the corresponding face 27, 28 of each of the carrier modules 210 as well as an outer circumferential surface of the peripheral portion 257 of each of the manifold tanks 253. However, each of the face plates 270 may alternatively be configured to abut the corresponding face 27, 28 of each the carrier modules 210 while abutting a surface of each of the peripheral portions 257 facing towards a surface of the opposing one of the peripheral portions 257. In either circumstance, the manifold tank 253, the carrier modules 210, and the face plates 270 are arranged relative to each other and coupled together in a manner wherein the coolant cannot escape the fluid channels 40 formed by the spaces between adjacent ones of the carrier modules 210. The described components may be coupled to each at the desired locations using any known coupling method, including the previously described aggressive coupling methods such as welding or brazing.

In some embodiments, one or more of the face plates 270 may be provided as an electrically conductive material to electrically couple each of the carrier modules 210 to each other in circumstances wherein it may be desirable to connect all of the battery cells 5 associated with the heat exchanger core 255 to one another such as when forming the negative busbar as described hereinabove. However, as explained hereinabove, any number of different electrical connections and configurations may be utilized with respect to the battery cells 5 while still appreciating the beneficial features of the structure of each of the carrier modules 210.

The heat exchanger assembly 250 operates in substantially similar fashion to the heat exchanger assembly 50 except that the spacing of the carrier modules 210 from one another and the removal of intervening heat exchanger tubes 42 leads to a more direct thermal path for the heat generated by the battery cells 5 to follow when the heat is being transferred to the coolant conveyed through the fluid channels 40. The configuration of FIGS. 7-9 also eliminates the need for additional components such as the header plates and heat exchanger tubes required in forming the heat exchanger assembly 50.

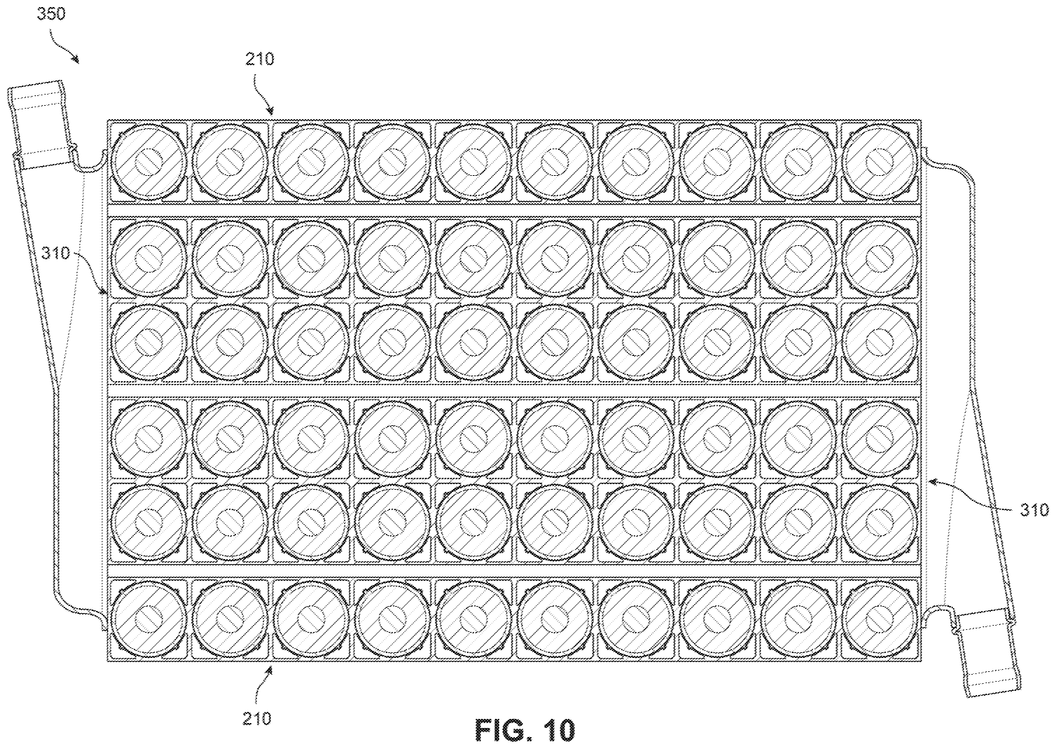

Lastly, FIG. 10 illustrates a heat exchanger assembly 350 according to yet another embodiment of the present invention. The heat exchanger assembly 350 is substantially identical to the heat exchanger assembly 250 except for the introduction of yet another double-rowed carried module 310 forming the innermost rows of the cell pockets 30 while the outermost rows of the cell pockets 30 are formed by the carrier modules 210 as disclosed in FIG. 7. Each of the carrier modules 310 accordingly includes three of the longitudinal members 22 and two rows of the cell pockets 30 in similar fashion to the carrier modules 110 of FIG. 6, only devoid of the formation of any of the coupling grooves 26 due to the alternative configuration of the heat exchanger assembly 350 wherein the longitudinal sides of the carrier modules 210, 310 are not coupled to each other or additional structures such as the aforementioned heat exchanger tubes.

It should be apparent from the foregoing description of the heat exchanger assemblies 50, 150, 250, 350 that additional combinations of the disclosed carrier modules 10, 110, 210, 310 may be utilized without necessarily departing from the scope of the present invention. For example, any repeating configuration of any of the carrier modules 10, 110, 210, 310 may be utilized without significantly altering the method of operation of the corresponding heat exchanger assembly.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A carrier module for a heat exchanger comprising:
a frame; and
a cell pocket merged with the frame, the cell pocket configured to receive a substantially cylindrical battery cell therein.

2. The carrier module of claim 1, wherein the cell pocket is substantially cylindrical in shape and includes an inner circumferential surface that is oblong in at least one direction.

3. The carrier module of claim 2, wherein the inner circumferential surface of the cell pocket is oblong in each of two perpendicular arranged directions.

4. The carrier module of claim 1, wherein the cell pocket is substantially cylindrical in shape and includes a variable radius measured between a center of the cell pocket and an inner circumferential surface of the cell pocket.

5. The carrier module of claim 4, wherein the radius varies between a minimum radius and a maximum radius, the maximum radius corresponding to a portion of the inner circumferential surface forming a connection point wherein the cell pocket merges with the frame.

6. The carrier module of claim 5, wherein the minimum diameter is present at a corrugation formed in the cell pocket, the corrugation configured to facilitate a flexing of the cell pocket.

7. The carrier module of claim 1, wherein the frame is comprised of at least one longitudinal member and at least one cross member arranged perpendicular to the at least one longitudinal member.

8. The carrier module of claim 7, wherein the cell pocket is comprised of a plurality of arcuate shell portions, wherein each of the arcuate shell portions connects one of the at least one cross members to one of the at least one longitudinal members.

9. The carrier module of claim 8, wherein at least one of the arcuate shell portions includes a corrugation formed therein, the corrugation configured to facilitate a flexing of the at least one of the arcuate shell portions.

10. The carrier module of claim 7, wherein the frame comprises two of the longitudinal members spaced from each other and a plurality of the cross members extending between the two longitudinal members, wherein one of the cell pockets is formed between each adjacent pair of the cross members.

11. The carrier module of claim 1, wherein the carrier module is formed from an electrically conductive material.

12. The carrier module of claim 12, wherein the carrier module includes a plurality of the cell pockets with each of the cell pockets configured to receive one of the battery cells therein, and wherein the carrier module forms a busbar in electrical communication with each of the battery cells disposed within the carrier module.

13. The carrier module of claim 1, wherein the frame includes at least one corrugation formed therein, the at least one corrugation including an outwardly facing concave surface configured to receive a brazing material therein.

14. The carrier module of claim 1, wherein the frame and the cell pocket are formed monolithically in a common manufacturing process.

15. The carrier module of claim 14, wherein the manufacturing process is an extrusion process.

16. A heat exchanger assembly comprising:
a first header tank;
a second header tank arranged opposite the first header tank; and
a heat exchanger core formed by a plurality of parallel arranged carrier modules and a plurality of fluid channels providing fluid communication between the first header tank and the second header tank, each of the carrier modules including a frame and at least one cell pocket merged with the frame, each of the at least one cell pockets configured to receive a substantially cylindrical battery cell therein, wherein each of the carrier modules is disposed adjacent at least one of the fluid channels.

17. The heat exchanger assembly of claim 16, wherein each of the fluid channels is formed by a heat exchanger tube abutting the frame of at least one of the carrier modules.

18. The heat exchanger assembly of claim 17, wherein the first header tank and the second header tank each include a header plate having tube openings for receiving the heat exchanger tubes therein.

19. The heat exchanger assembly of claim 16, wherein at least one of the carrier modules includes two rows of the cell pockets merged with the frame.

20. The heat exchanger assembly of claim 16, wherein each of the fluid channels is formed by a space present between adjacent ones of the carrier modules.
